(19) United States
(12) Patent Application Publication
(10) Pub. No.: US 2019/0015895 A1
(43) Pub. Date: Jan. 17, 2019

(54) Method for Producing Textured Porous Metals

(71) Applicant: University of North Texas, Denton, TX (US)

(72) Inventor: Marcus Young, Oak Point, TX (US)

(21) Appl. No.: 16/069,562

(22) PCT Filed: Jan. 15, 2016
(86) PCT No.: PCT/US2016/013683

§ 371 Date: Jul. 12, 2018

(51) Int. Cl. B22D 25/00; B22C 9/10; B33Y 80/00

(52) U.S. Cl. CPC B22D 25/005; B33Y 80/00; B22C 9/105

(57) ABSTRACT

The present invention includes a method of producing a porous metal casting comprising: forming a salt preform structure in a 3D printed polymeric matrix comprising one or more openings in a heat resistant vessel; removing the 3D printed polymeric matrix by dissolving, melting, or sintering; adding, melting or casting one or more metals into the salt preform structure; and dissolving the salt preform structure to produce the porous metal casting.

### TECHNICAL FIELD OF THE INVENTION

The present invention relates in general to the field of producing textured materials, and more particularly, to a method for producing textured porous metals.

### BACKGROUND OF THE INVENTION

Without limiting the scope of the invention, its background is described in connection with porous materials.

Zinc oxide (ZnO) nanowires have been investigated by many researchers due to their ease of fabrication, outstanding optical/electrical properties, and broad range of applications [1,2]. Some of the applications of ZnO include solar cells [2,3], gas sensors [4], photocatalysts [5], piezoelectrics [6], and nanowire laser devices [7]. These nanowires have been produced using various types of techniques that include hydrothermal [3], vapor-liquid-solid [8], pulsed laser deposition [9], thermal evaporation [10], sol-gel deposition [11], and sputtering [12].

The growth of ZnO 1D nanostructures was also studied as a function of substrate architecture [13]. The effect of surface roughness/texture was investigated by creating ZnO nanostructures on alkaline etched (100) Si substrates [13]. The authors reported that a textured silicon micro-pattern drives ZnO 1D growth on all the {111} exposed faces, resulting in sea sponge-like ZnO nano-architectures. In addition, these structures were also produced on graphene foams for ultraviolet photodetection [14], reticulated ZnO for the degradation of azo dye molecules [15], and macroporous SiO₂ composites for biocatalytic synthesis [16]. The main purpose for creating 1D nanostructures on these complex surfaces is to further increase the total surface area of the grown 1D structures, which in turn will enhance their optical, electrical, and photocatalytic properties.

### SUMMARY OF THE INVENTION

In one embodiment, the present invention includes a method of producing a porous metal comprising: forming a salt preform structure comprising one or more openings in a vessel in a 3D polymer; adding one or more metals to the salt preform structure; melting the one or more metals into the salt preform structure in the vessel; and dissolving the salt preform to produce the porous metal or alloy. In one aspect, the one or more metals are a metal alloy. In another aspect, the salt is NaCl, NaF, KCl, KF, LiCl, LiF, CaCl₂, CaF₂, BaCl₂, BaF₂, SrCl₂, SrF₂, MgCl₂, MgF₂, MgO, CaO, BaO, SrO, Na₂O and related oxides thereof. In another aspect, the salt is a Group I element containing salt, is a nitrate, a sulfate, a sulfide, a hydroxide, a carbonate, a phosphate, a fluoride, an oxide, a silver, a lead, a mercury, an antimony, or a bismuth salt. In another aspect, the vessel is a crucible. In another aspect, the method further comprises the step of making the salt preform by obtaining a 3D printed mesh, forming or packing salt crystals in the 3D printed mesh, and removing the 3D mesh by burning or melting the 3D printed mesh to leave a salt preform structure. In another aspect, the method further comprises the step of making the salt preform by obtaining a 3D printed mesh, forming or packing salt crystals in the 3D printed mesh, and removing the 3D mesh by burning or melting the 3D printed mesh and sintering the salt preform structure. In another aspect, the step of adding the one or more metals to the salt preform structure is defined further as comprising melting the one or more metals and casting the metal into the salt preform structure. In another aspect, a vent is positioned in fluid communication with the salt preform structure to permit gases or liquids to escape the salt preform structure during the addition or melting of the one or more metals into the salt preform structure. In another aspect, the step of dissolving the salt preform includes the addition of a solvent that dissolves the salt. In another aspect, the salt is dissolved with a solvent selected from at least of partially water soluble, water soluble, soluble in acids or alcohol, wherein the solvent does not react with the metal. In another aspect, the solvent is selected from HCl, HF, methanol, ethanol, propanol, butanol, ammonia, acetone, acetic acid, nitric acid, and combinations thereof. In another aspect, the one or more metals are selected from at least one or more metals selected from aluminum, antimony, bismuth, chromium, cobalt, copper, gallium, germanium, gold, hafnium, indium, iron, lead, magnesium, mercury, nickel, potassium, rhodium, tin, titanium, tantalum, uranium, plutonium, scandium, vanadium, zirconium, alloys, or oxides thereof. In another aspect, the salt preform structure is defined further as comprising one or more opening in one or more shapes selected from at least one of wires, blocks, cubes, spheres, cones, pyramids, vias, cylinders, pads, mesh, 3D periodic arrays. In another aspect, the salt preform structure is removed by dissolving the salt.

Yet another embodiment includes a method of producing a porous metal casting comprising: forming a salt preform structure in a 3D printed polymeric matrix comprising one or more openings in a heat resistant vessel; removing the 3D printed polymeric matrix by dissolving, melting, or sintering; adding, melting or casting one or more metals into the salt preform structure; and dissolving the salt preform structure to produce the porous metal casting. In one aspect, the one or more metals are a metal alloy. In another aspect, the salt is NaCl, NaF, KCl, KF, LiCl, LiF, CaCl₂, CaF₂, BaCl₂, BaF₂, SrCl₂, SrF₂, MgCl₂, MgF₂, MgO, CaO, BaO, SrO, Na₂O and related oxides thereof. In another aspect, the salt is a Group I element containing salt, is a nitrate, a sulfate, a sulfide, a hydroxide, a carbonate, a phosphate, a fluoride, an oxide, a silver, a lead, a mercury, an antimony, or a bismuth salt. In another aspect, the vessel is a crucible. In another aspect, the step of adding the one or more metals to the preform structure is defined further as comprising melting the one or more metals and casting the metal into the salt preform structure. In another aspect, a vent is positioned in fluid communication with the salt preform structure to permit gases or liquids to escape the salt preform cast during the addition or melting of the one or more metals into the salt preform structure. In another aspect, the step of dissolving the salt preform structure includes the addition of a solvent that dissolves the salt. In another aspect, the salt is at least partially water soluble. In another aspect, the or more metals are selected from at least one or more metals selected from aluminum, antimony, bismuth, chromium, cobalt, copper, gallium, germanium, gold, indium, iron, lead, magnesium, mercury, nickel, potassium, rhodium, tin, titanium, uranium, plutonium, scandium, zirconium, alloys, or oxides thereof. In another aspect, the salt preform structure is defined further as comprising one or more opening in one or more shapes selected from at least one of wires, blocks, cubes, spheres, cones, pyramids, vias, cylinders, pads, mesh, 3D periodic arrays.

### BRIEF DESCRIPTION OF THE DRAWINGS

For a more complete understanding of the features and advantages of the present invention, reference is now made to the detailed description of the invention along with the accompanying figures and in which:

FIG. 1 is a description of salt preform fabrication method.

FIG. 2 shows selected Zn substrates used to grow ZnO nanowires.

FIG. 3 is a 3D rendering using Autodesk Inventor™ of the porous 3D polymeric structure.

FIG. 4A shows a top view and FIG. 4B shows a side view of the 3D printed ABS 3D polymeric structure.

FIG. 5 shows an image of the sintered salt preform in the crucible after polymer burnout.

FIGS. 6A and 6B show optical images of FIG. 6A porous Zn structure with dimensions 1 cm³ and FIG. 6B is a detailed view of an individual strut showing the textured surface from the salt preform.

FIGS. 7A and 7B are SEM micrographs depicting nanowires synthesized (FIG. 7A) without and (FIG. 7B) with thermal treatment.

FIGS. 8A to 8C are SEM micrographs depicting nanowires synthesized on (FIG. 8A) smooth, (FIG. 8B) fine-grained, and (FIG. 8C) coarse-grained substrates.

FIG. 9 is an SEM micrograph of a porous structure.

FIGS. 10A and 10B show NaCl crystalline powder imaged by optical microscopy at 5×.

FIG. 11 shows 3D rendering of ABS matrix (Left), Finished 3D printed ABS matrix (Right).

FIG. 12 shows sintered salt preform in crucible.

FIG. 13 shows un-cut Zn foam.

FIG. 14 shows a process diagram of designed Zn foam production process.

FIGS. 15A and 15B show different sides of compression testing sample macroscopically imaged.

FIGS. 16A and 16B show various images of struts on the outer surface of Zn foam at a 5× magnification on an optical microscope.

FIGS. 17A and 17B show various images of struts on the outer surface of Zn foam at a 5× magnification on an optical microscope.

FIGS. 18A and 18B show side by side comparison of NaCl crystals (FIG. 18A) and Zn foam strut at 5× (FIG. 18B).

FIGS. 19A and 19B show SEM images at 25× of Zn foam (FIG. 19A) and SEM image at 250× of Zn foam (FIG. 19B).

FIG. 20 shows EDS graph for Zn foam.

FIGS. 21A and 21B show SEM image of Zn foam with ZnO nanostructures at 30× (FIG. 21A) and SEM image of Zn foam with ZnO nanostructures at 2500× (FIG. 21B).

FIGS. 22A and 22B show SEM image of Zn foam with ZnO nanostructures at 250× (FIG. 22A) and SEM image of Zn foam with ZnO nanostructures at 3000× (FIG. 22B).

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

### Example 1—Growth of ZnO Nanowires on Textured and Porous Zinc Surfaces

Growth of ZnO nanowires on textured and porous Zn surfaces is demonstrated using the hydrothermal process. Textured Zn surfaces were produced using a salt-preform method. The growth morphology of ZnO nanowires on surfaces with various degrees of surface roughness was compared using scanning electron microscopy (SEM). The nanowires had a tendency to grow vertically on flat surfaces and were interwoven on textured surfaces. In addition, the nanowire diameter was found to decrease with an increase in surface waviness. Zn foams were produced using a salt-preform method, which was preceded by a polymeric-foam structure produced using a 3D printer. One-dimensional ZnO nanostructures were created on the inside surfaces of these foams. Growth of nanostructures inside the porous structures required the use of a hot plate equipped with a magnetic stirring rod. 1D structures with lengths in excess of 50 m were grown by repeating the hydrothermal process in a fresh solution three times. This technology may be used to create 1D structures in porous media for applications in hydrogen storage, photocatalytic devices, and photovoltaic cells.

Zinc oxide (ZnO) nanowires have been investigated by many researchers due to their ease of fabrication, outstanding optical/electrical properties, and broad range of applications [1,2]. Some of the applications of ZnO include solar cells [2,3], gas sensors [4], photocatalysts [5], piezoelectrics [6], and nanowire laser devices [7]. These nanowires have been produced using various types of techniques that include hydrothermal [3], vapor-liquid-solid [8], pulsed laser deposition [9], thermal evaporation [10], sol-gel deposition [11], and sputtering [12].

The growth of ZnO 1D nanostructures was also studied as a function of substrate architecture [13]. The effect of surface roughness/texture was investigated by creating ZnO nanostructures on alkaline etched (100) Si substrates [13]. The authors reported that a textured silicon micro-pattern drives ZnO 1D growth on all the {111} exposed faces, resulting in sea sponge-like ZnO nano-architectures. In addition, these structures were also produced on graphene foams for ultraviolet photodetection [14], reticulated ZnO for the degradation of azo dye molecules [15], and macroporous SiO₂ composites for biocatalytic synthesis [16]. The main purpose for creating 1D nanostructures on these complex surfaces is to further increase the total surface area of the grown 1D structures, which in turn will enhance their optical, electrical, and photocatalytic properties.

The goal of the current research is to produce ZnO 1D nanostructures on a variety of Zn surfaces using the hydrothermal process. First, the 1D structures are grown on textured Zn surfaces that are produced using a salt-preform method. Then, the same synthesis method is utilized to grow 1D nanostructures inside foams that were produced using a two-step method that combines the salt-preform method with a polymeric foam created using a 3D printer. The morphology of the resulting structures is studied using scanning electron microscopy (SEM).

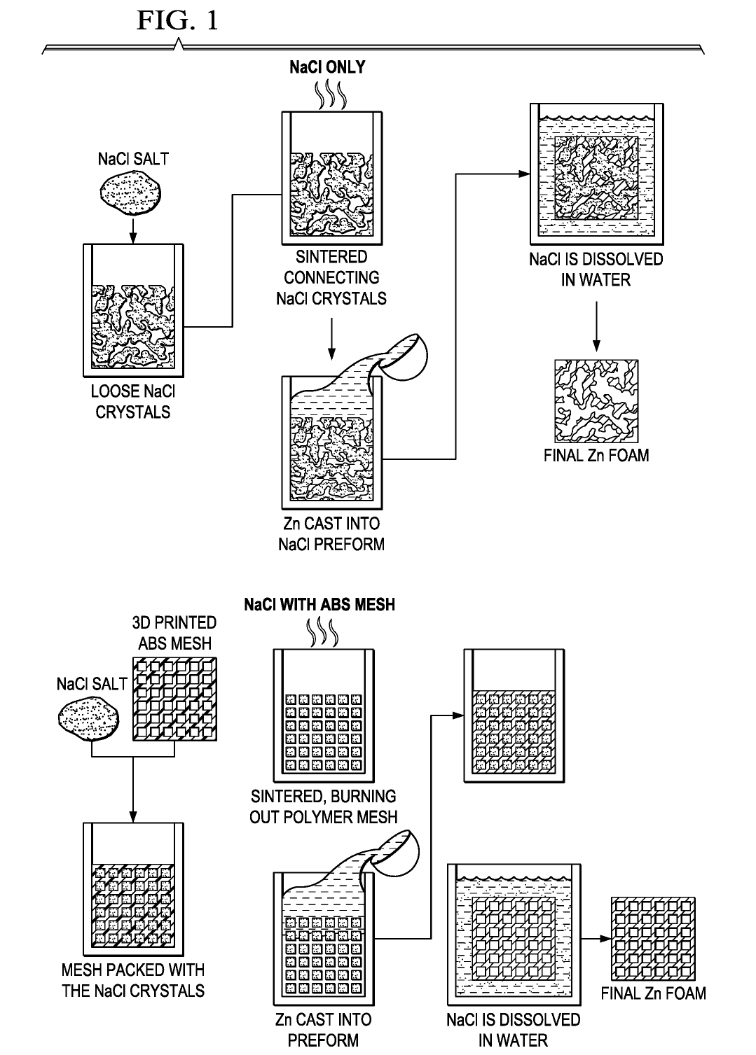

Materials. 99.995% Zn metal from King Supply, Inc. (Franklin Park, Ill.) was selected due to its low melting temperature (419.5° C.) and its natural compatibility with the growth of ZnO. NaCl salt was selected due to its low cost, dissolvability in H₂O, and low melting temperature (801° C.). NaCl crystalline powders with the granule size ranging from 100-1000 m or 100-250 m were used. As illustrated in the optical image in FIG. 1, the NaCl crystalline powders consisted predominantly of faceted cuboidal crystals. Graphite crucibles were manufactured by Poco Graphite, Inc. (Decatur, Tex.). The 3D printer material consists of ABSplus™-P430 thermoplastic or a dissolvable SR-30 Soluble Support polymer.

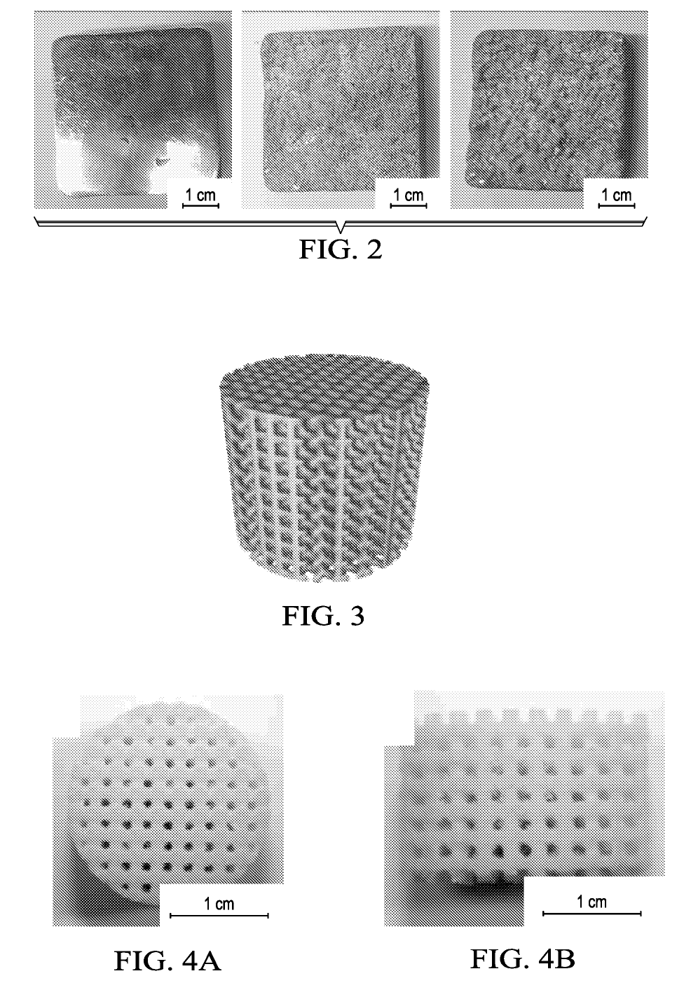

Fabrication of textured surfaces. As illustrated in the processing schematic shown in FIG. 1, textured surfaces were created using a salt preform cast replication method. This continuous solid/porous alloy is created by packing salt powders of a specified size range into a graphite crucible and then sintering at approximately one half to two-thirds the melting temperature of the salt. After sintering, the Zn ingot is placed on top of the salt preform in the graphite crucible and then the crucible is heated in vacuum to a temperature above the Zn melting temperature but below the melting temperature and sintering temperature of the salt preform. During metal infiltration, the chamber is backfilled with argon gas. The resulting alloy/salt composite is then placed in a liquid solution to dissolve away the salt preform, leaving behind the solid/porous alloy. Control of the texture morphology was achieved using salt powders of different sizes. FIG. 2 shows images of selected samples to be investigated in the course of this study.

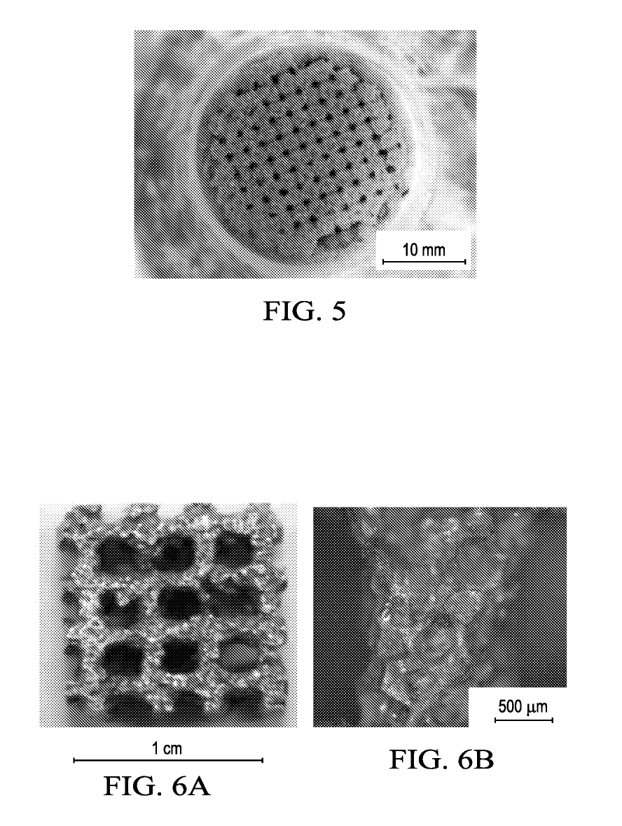

Fabrication of porous structures. A Stratasys Mojo® 3D Printer was used to create a porous 3D polymeric structure. As shown in FIG. 3, a 3D model of the polymeric structure was created using Autodesk Inventor™ 3D CAD software. The polymeric structure has a mesh with 1 mm spacing measuring 20 mm in height and 30 mm in diameter. Once printed, the 3D polymeric structure is placed in a chemical bath to remove the soluble support structure. The remaining ABS 3D polymeric structure (shown in FIGS. 4A and 4B) is then packed with salt in an alumina crucible and heated to 700° C. for 2.5 hours, thus burning out the polymer and sintering the salt (FIG. 5). Zn metal is then placed in the crucible on top of the sintered salt preform and heated to 500° C. and held for 1 hour. The molten metal flows into the salt preform, leaving a cast Zn—NaCl salt composite, which is subsequently placed in a water bath where the salt is dissolved, resulting in a porous Zn structure, which exhibits the same salt texture as that in FIG. 2 for the flat samples. A porous Zn structure with dimensions 1 cm³ is shown in FIG. 6A. The surface morphology of the porous Zn structure reveals many cuboidal shaped cavities which resulted from casting into the salt preform, as illustrated in FIG. 6B.

Synthesis of ZnO nanowires. ZnO 1D structures were grown on a Zn surface using a two-step method. The first step consists of thermally oxidizing the textured surfaces by annealing the Zn substrates at 300° C. using a gradient rate of 6° C./min and a hold time of 1 hour. The thermal oxidation was shown to be a necessary step to create a seed layer for the growth of nanowires.

After the oxidation process, nanowires were grown on the textured surfaces using the hydrothermal method in an aqueous medium [1]. The aqueous solution consisted of zinc nitrate hexahydrate (0.595 g), hexamethyltetramine (HMTA) (0.280 g), and 160 mL of distilled water. The pH was maintained in the 6-7 range and was adjusted, when necessary, using either NaOH or HCl. The container was sealed with foil and electrical tape and placed in a 75° C. oven for 24 hours. The substrates were washed with deionized water and allowed to dry post-synthesis.

Characterization. Crystal structure identification was performed using a Rigaku III Ultima X-ray diffractometer (XRD Rigaku Corporation, Tokyo Japan) with CuK_{α} radiation of wavelength of 1.54 nm. SEM was carried out to evaluate the material topography using FEI Quanta ESEM (FEI Company, Hillsboro, Oreg.).

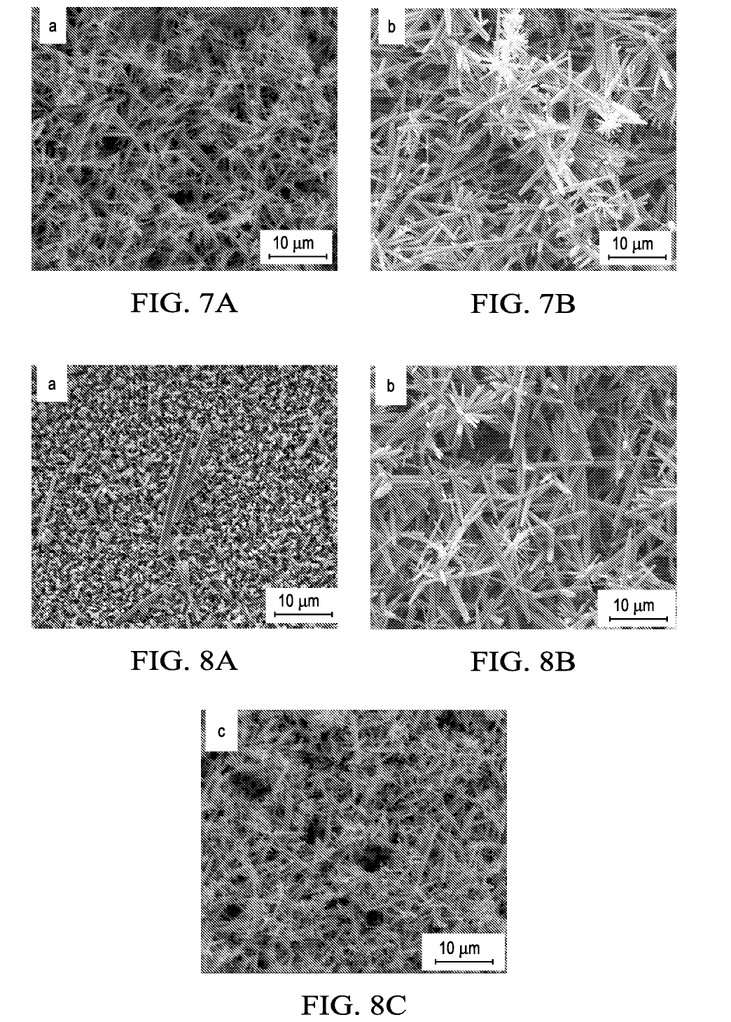

FIGS. 7A and 7B show SEM micrographs for nanowires grown on polished surfaces that were untreated and treated, respectively. A comparison between the two micrographs reveals that thermal oxidation resulted in the growth of longer wires that also had larger diameters. This is a result of the better crystal structure of the seed oxide surface as a result of the annealing process. Hence, in the remainder of this study, all surfaces were annealed using the conditions described in the experimental section prior to the growth of nanostructures. This ensures the growth of longer and better quality ZnO nanowires.

FIGS. 8A to 8C depict selected areas of samples produced on (FIG. 8A) smooth, (FIG. 8B) fine-grained, and (FIG. 8C) coarse-grained Zn substrates. Nanowires had a tendency to grow more vertically on smooth surfaces (FIG. 8A) and were more interwoven with an increase in surface waviness ((FIG. 8B) and (FIG. 8C)). Interestingly, nanowire diameters were found to decrease with an increase in surface waviness. The figures on the right hand side show SEM micrographs for longer nanowires that have been produced by repeating the hydrothermal process three times.

The length of the nanowires and their interlacing was found to increase with the increase in synthesis time.

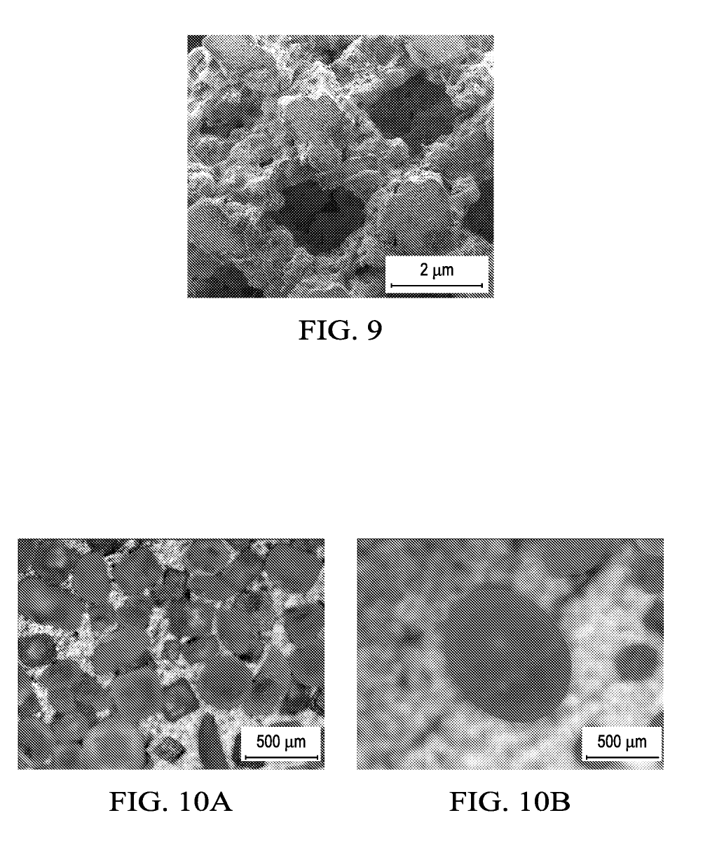

FIG. 9 shows an SEM image of a porous Zn structure. Pores were approximately 1.5×1.5×1.5 mm³ in dimension. The use of the hydrothermal method described in the experimental section resulted in the growth of nanowires only on the outside surface of the foams rather than also inside the pores. The synthesis of 1D structures on all surfaces required the use of a beaker that contained a magnetic stirring rod that was heated at 95° C. using a hot plate.

ZnO nanowires with a length of about 50 m were successfully grown using the hydrothermal process on textured and porous Zn surfaces. The textured Zn surfaces were created using a salt preform cast replication method, while the porous Zn surfaces were created using a polymeric-foam structure, which acted as a structural place holder for the salt preform cast replication method. Thermal oxidation of the Zn surfaces was necessary for the growth of long and good quality 1D structures. ZnO structures grown on rough surfaces were more interwoven than on polished surfaces. 1D ZnO nanostructures were also produced on the inside surface of Zn foams that were produced using a salt preform cast replication method. Growth of nanostructures inside the porous structures required the use of a magnetic stirring rod to facilitate the flow of the solution inside the porous structure. Nanostructures with lengths in excess of 50 m were fabricated by repeating the hydrothermal process in a fresh solution multiple times.

### Example 2—Varied Length-Scale Porous Metallic

Open cell porous metallic structures exhibit unique physical and mechanical properties such as high strength, high impact resistance, lightweight, and excellent heat transfer, which make them ideal candidates for many engineering applications. In this project, macro- and micro-scale porous structures will be designed by casting pure Zn metal into salt preforms which have controlled regular spacing based on 3D polymer structure. These macro- and micro-scale porous structures will then be modified by chemical routes such as hydrothermal electrochemical deposition to create nano-scale features.

The combination of the physical and mechanical properties exhibited by metal foams, such as their high thermal conductivity, low density, large surface area and high strength to weight ratio has made them a relevant material in many areas of industry. Applications of these foams include, heat sinks, biomedical implants, and energy dissipation. Additional benefits of metal foams compared to its polymeric counterparts include the high service temperature, electrical conductivity, and a higher stiffness allowing for more energy dissipation.

Metal foams consist of two types cellular structures, open and closed, which are shown in FIG. 1 [2-3]. Closed cell foams contain small pockets of trapped gas causing the foam to be more structurally sound due to their higher density [3]. Closed cell foams often have very high impact absorbing properties making them ideal for damping components. Open cell foams, on the other hand, generally have a higher amount of porosity resulting in a much higher surface area making them ideal for heat exchangers and filtration devices for high temperature applications [2-3].

Many manufacturing processes exist, but when making open cell foams infiltration casting into a leachable powder emerges as cost effective and tailorable method of creating a metal foam. With this method a salt preform is created and cast into, making a non-uniform open cell porous metal. By creating a 3D printed structure and packing the salt around it, a preform with uniform spacing can be created. This newly designed method combining 3D printed structures with salt preform infiltration casting creates a porous metal with regular spacing and an interesting surface morphology that both increases surface area and promotes the growth of nanoscale features.

Materials. The materials selected for this process design were Zn metal and NaCl salt. Zinc metal was chosen due to its wide range of applications including biomedical and optoelectronic, as well as its low melting temperature and ability to grow ZnO nanowires. This low melting temperature allows for the use of a NaCl salt, which is both inexpensive and easily dissolvable in water, as a preform. The salt used was a NaCl crystalline powder with the granule size ranging from 100-1000 m with mainly cuboidal crystals, some having rounded edges. These granules were imaged with optical microscopy and measured to determine length and shape. This is shown in FIGS. 10A and 10B.

FIGS. 10A and 10B shows NaCl crystalline powder imaged by optical microscopy at 5×. The 3D printed matrix was made with ABSplus, which has a decomposition temperature of 420° C. It is also classified by the Standard for Safety of Flammability of Plastic Materials for Parts in Devices and Appliances testing, UL 94, as HB, which has a slow burning rate. In addition to the ABS there is intentionally dissolvable scaffolding material that is used to support the structure while it is being printed. This material is dissolved in a chemical bath after printing.

Designed process. The designed foam production process begins by 3D printing an ABS mesh with 1 mm webbing with 1 mm spacing in a the form of a cylinder measuring 20 mm tall and 30 mm in diameter. This is done using a Stratasys Mojo 3D printer.

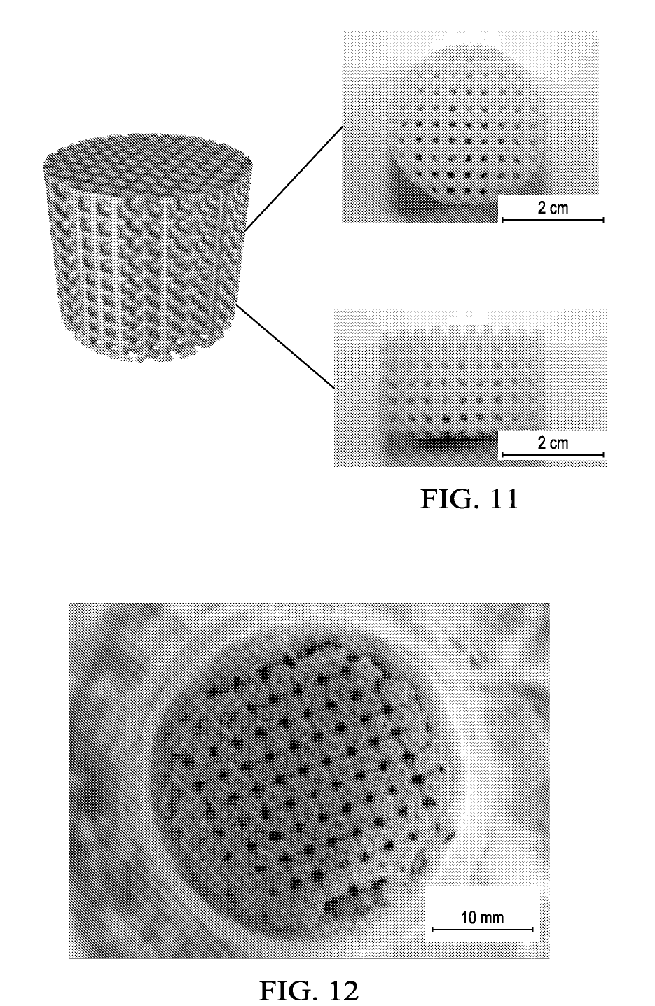

FIG. 11 shows a 3D rendering of ABS matrix (Left), Finished 3D printed ABS matrix (Right). After the support material is dissolved, the mesh is placed in a crucible of similar diameter, and is then packed with salt. This polymer is burned out at around 400° C., and the salt matrix is sintered at 700° C. for 2.5 hours in a Deltech box furnace.

FIG. 12 shows a Sintered salt preform in crucible. This leaves a negative in the form of necked NaCl particles which is then cast into with molten Zn after placing a piece of ceramic within the crucible to allow for air to vent during the casting. After an hour in the furnace the ceramic piece is removed breaking the surface tension of the oxide layer allowing the molten Zn to flow into the salt preform. The cast Zn and salt matrix are removed from the crucible and placed in a water bath where the salt is dissolved leaving a porous Zn structure.

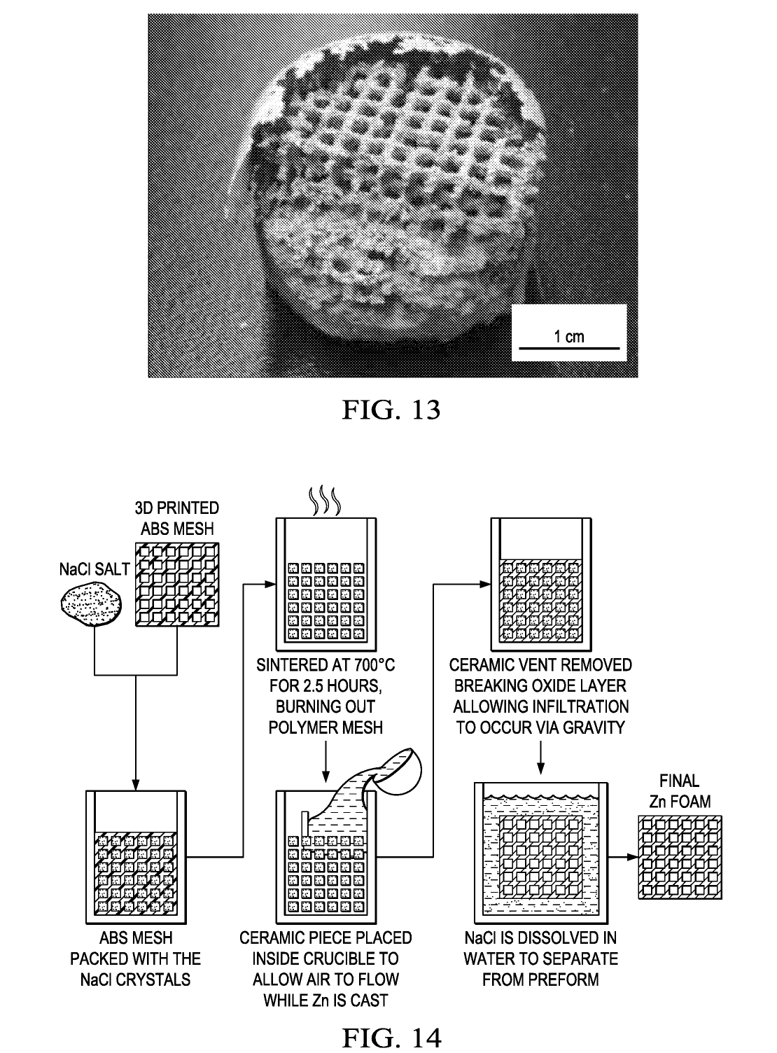

FIG. 13 shows an un-cut Zn foam. FIG. 14 shows a process diagram of designed Zn foam production process. After a foam was made zinc oxide nano-wires were grown on the sample via hydrothermal electrochemical deposition. A solution was prepared of Zinc Nitrate (80 ml) and Hexamethylenetetramine (80 mL). A porous Zn sample was placed in the bath for 24 hours in a box furnace at 75° C.

Standards for testing follow ASTM E9-09 Standard Test Methods of Compression Testing of Metallic Materials at Room Temperature. This shows the procedure necessary to obtain a reliable compressive strength number for comparison across metal structures and systems. [16]

The constraints for this project are largely economic. The cost of manufacture is one of the largest problems preventing integration of metal foams into product design. The processing method chosen, infiltration casting with a salt preform, is an inexpensive and scalable method of production that could make open cell metal foams inexpensive promoting wider adoption in industry. Another constraint is materials selection in regards to nanostructure growth. In many materials, it is difficult or impossible to grow nanostructures making selection of the metal matrix key in producing a successful nanostructure enhanced foam.

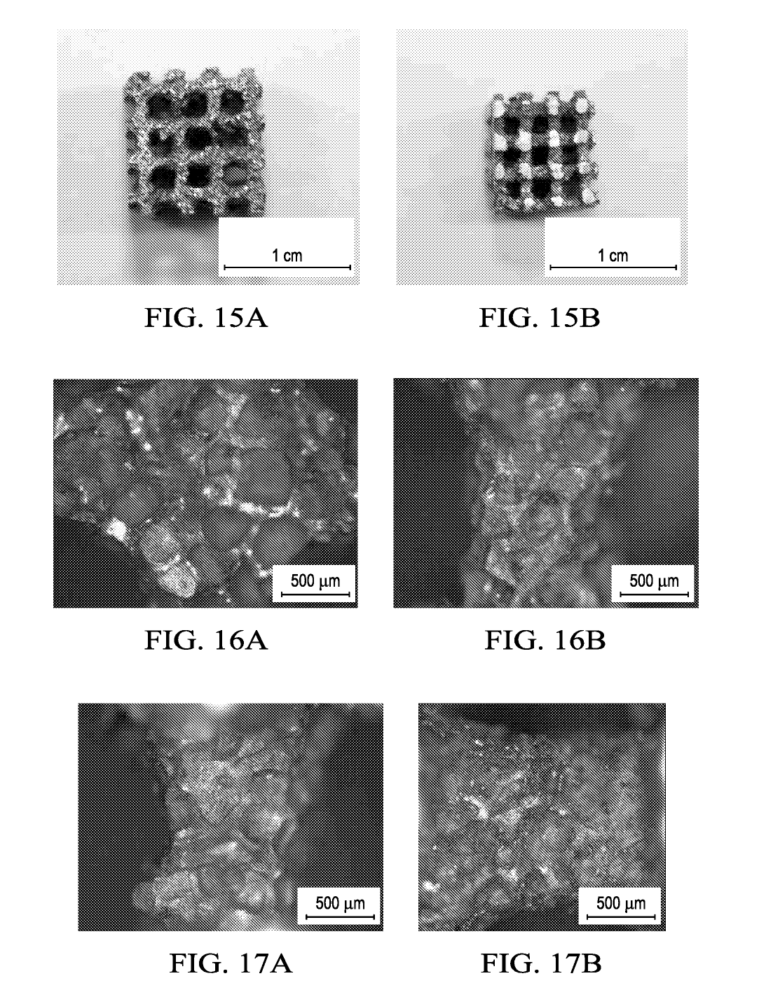

FIGS. 15A and 15B show the surface of the compression testing sample. From a macroscopic view, a change in surface morphology can be observed, in addition some of the individual struts are incomplete. This could be due to salt preform imperfections caused by collapse or improper packing.

FIGS. 16A, 16B, 17A and 17B show the same sample imaged at 5× on an optical microscope. Here the surface morphology is shown in more detail, revealing round and cuboidal shaped cavities along the struts and cross sections of the Zn foam sample.

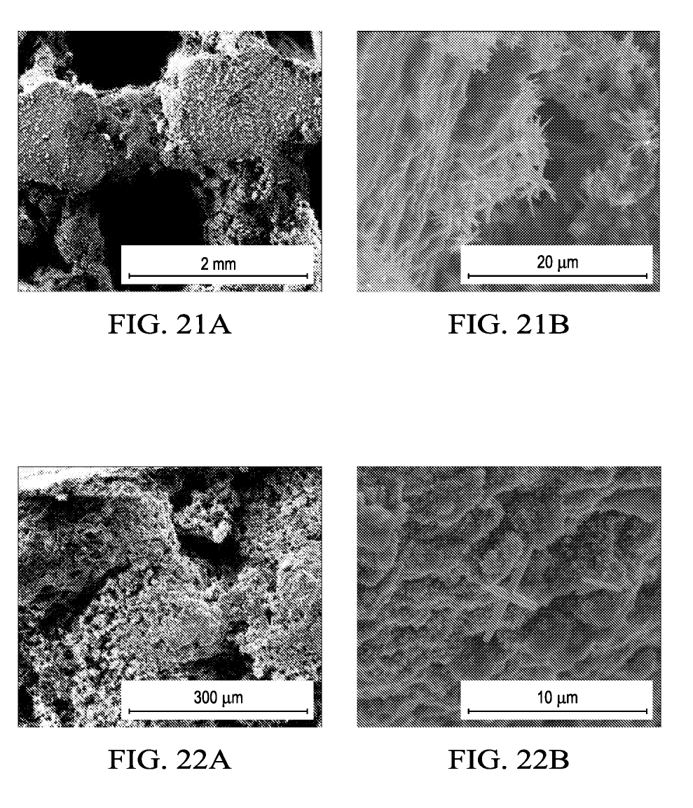

The cavities are compared with the salt used in the preform at the same 5× magnification in FIGS. 17A and 17B show, making the similarities in shape and size are clear. This shows that the NaCl salt has changed the surface morphology of the foam. FIGS. 17A and 17B show side by side comparison of NaCl crystals and Zn foam strut at 5×. FIGS. 21A and 22B show the same sample imaged with scanning electron microscopy (SEM). These images have a larger depth of field allowing for all of the cavities in view to be in focus.

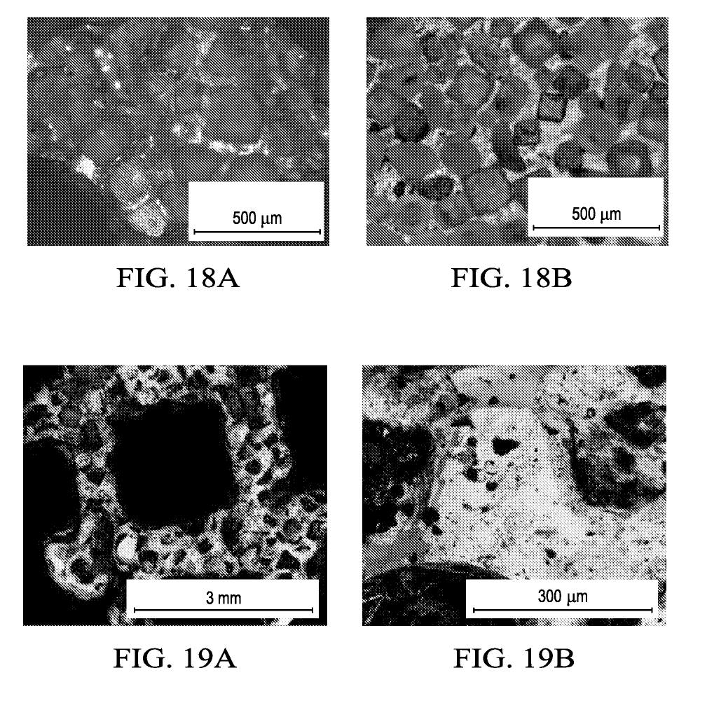

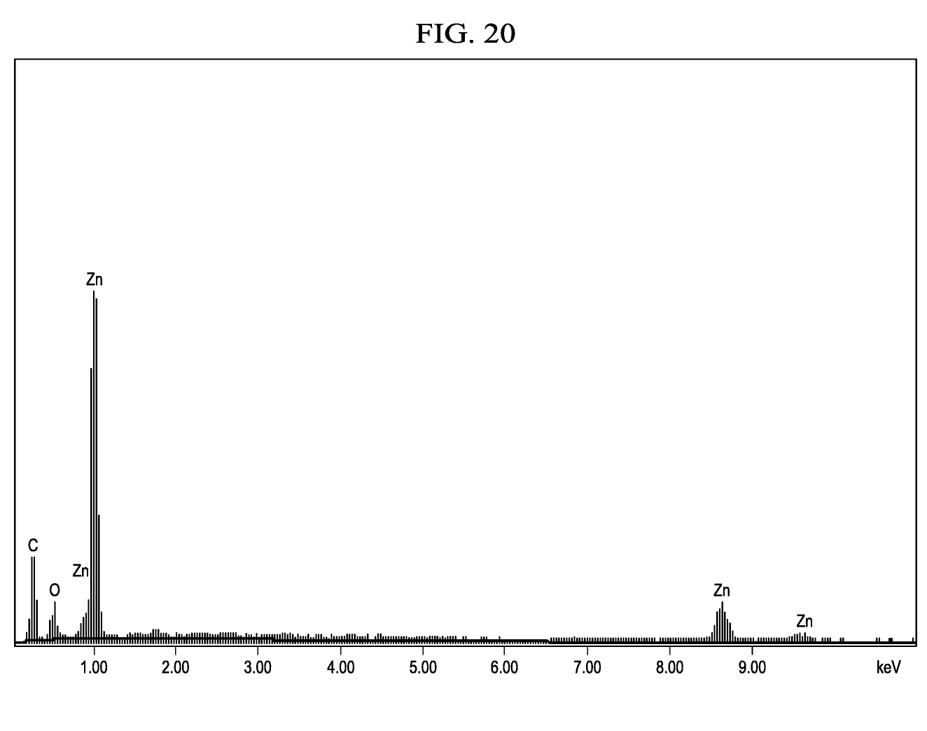

FIGS. 18a and 18B are side by side comparison of NaCl crystals and Zn foam strut at 5×. FIG. 19A shows an SEM image at 25× of Zn foam. In FIG. 19A shows the SEM is images at 250× showing many small dark regions which are divits in the surface, and in the bottom left corner of the crossection there is a white region of similar size to the other cavities. This white region is a reminant piece of NaCl salt left in the structure. In FIG. 19B the same sample is imaged at 250× and shows various cavities surrounding a high point in the center. FIG. 20 is an EDS graph showing the composition inside of one of the dark regions in the above micrograph. It displays peaks of zinc, oxygen, and carbon. The zinc and oxygen come from the structure itself and the oxidation that incurred from sample preparation, and the traces of carbon come from the polymer burnout during the sintering of the salt preform.

FIG. 20 is an EDS graph for Zn foam. FIGS. 21A-B and 22A-B show a porous Zn foam with ZnO nano wires grown on the surface via hydrothermal electrochemical deposition. FIGS. 14-16A-B are on the external surface of the foam while FIGS. 21A and 21 B show the inside of the foam matrix.

FIG. 21A is an SEM image of Zn foam with ZnO nanostructures at 30×. FIG. 21B is an SEM image of Zn foam with ZnO nanostructures at 2500×. FIG. 22A is an SEM image of Zn foam with ZnO nanostructures at 250×. FIG. 22B is an SEM image of Zn foam with ZnO nanostructures at 3000×.

Due to the size constraints for the ASTM E9-09 compression testing standards, our sample was not large enough to be tested, but with the scalability of the designed production process a sample of the correct size can be produced in the future.

Infiltration casting into a salt perform is a cost effective and scalable way to manufacture metal foams. The property enhancement due to the nano-scale features could make metal foams usable in an even wider range of applications. In addition, the surface morphology changes caused by the salt add surface area and promote nanowire growth. Lastly this process designed is an efficient way to create a continuous and complicated open cell porous metal structures.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

### Example 1

[1] Z. L. Wang, Zinc oxide nanostructures: growth, properties and applications, J. Phys.: Condens. Matter 16 (2004) R829-R858.
[2] X. Wang, J. Song, Z. L. Wang, Nanowire and nanobelt arrays of zinc oxide from synthesis to properties and to novel devices, J. Mat. Chem. 17 (2007) 711-720.
[3] C. P. Burke-Govey, N. O. V. Plank, Review of hydrothermal ZnO nanowires: Toward FET applications, J. Vac. Sci. Technol. B 31 (2013) 06F101
[4] Miller, Derek R.; Akbar, Sheikh A.; Morris, Patricia A, Nanoscale metal oxide-based heterojunctions for gas sensing: A review, Electrochemica Acta 127 (2014) 467-488.
[5] Y. Li, G. Yuan, R. Liu, S. Zhou, S. W. Sheehan, D. Wang, Semiconductor nanostructure-based photoelectrochemical water splitting: A brief review, Chem. Phys. Lett. 507 (2011) 209-215.
[6] Fang, Xue-Qian; Liu, Jin-Xi; Gupta, Vijay Fundamental formulations and recent achievements in piezoelectric nano-structures: a review, Nanoscale 5 (2013) 1716-1726
[7] M. A. Zimmler, F. Capasso, S. Miller, C. Ronning, Optically pumped nanowire lasers: invited review, Semicond. Sci. Technol. 25 (2010) 024001
[8] S. Shafiei, A. Nourbakhsh, B. Ganjipour, M. Zahedifar, G. Vakili-Nezhaad, Diameter optimization of VLS-synthesized ZnO nanowires, using statistical design of experiment, Nanotechnology 18 (2007) 355708
[9] Varanasi, C. V.; Leedy, K. D.; Tomich, D. H.; Subramanyam, G.; Look, D. C. Improved photoluminescence of vertically aligned ZnO nanorods grown on BaSrTiO3 by pulsed laser deposition. Nanotechnology 2009, 20, doi: 10.1088/0957-4484/20/38/385706.
[10] Ham, H.; Shen, G.; Cho, J. H.; Lee, T. J.; Seo, S. H.; Lee, C. J. Vertically aligned ZnO nanowires produced by a catalyst-free thermal evaporation method and their field emission properties. Chem. Phys. Lett. 2005, 404, 69-73.
[11] Zhang, N.; Yi, R.; Shi, R. R.; Gao, G. H.; Chen, G.; Liu, X. H. Novel rose-like ZnO nanoflowers synthesized by chemical vapor deposition. Mater. Lett. 2009, 63, 496-499.
[12] K. Polychronopoulou, S. M. Aouadi, B. Sirota, D. S. Stone, L. Wang, P. Kohli, M. McCarroll, Hierarchical structures produced using unbalanced magnetron sputtering for photocatalytic degradation of Rhodamine 6G dye, J. Nanoparticle Research 16 (2014) 1-11
[13] M. E. Fragalà, A. Di Mauro, Grazia Litrico, Filippo Grassia, Graziella Malandrino, Gaetano Foti, Controlled large-scale fabrication of sea sponge-like ZnO nanoarchitectures on textured silicon CrystEngComm, 2009, 11, 2770-2775
[14] B. D. Boruah, A. Mukherjee, S. Sridhar, A. Misra, Highly dense ZnO nanowires grown on grapheme foam for ultraviolet photodetection, ACS Appl. Mater. Interfaces 7 (2015) 10606-10611
[15] A. Kocaku akoglu, M. Da\check{g}lar, M. Konyar, H. C. Yatmaz, K. Öztürk, Photocatalytic activity of reticulated ZnO porous ceramics in degradation of azo dye molecules, J. European Ceramic Society 35 (2015) 2845-2853
[16] C.-Y. Shang, W.-X. Li, R.-F. Zhang, Immobilization of Candida rugosa lipase on ZnO nanowires/macroporous silica composites for biocatalytic synthesis of phytosterol esters, Materials Research Bulletin 68 (2015) 336-342

### REFERENCES

### Example 2

[1] De Meller, M. A. French Patent 615,147 (1926)
[2] Banhart, J. (2001). Manufacture, characterisation and application of cellular metals and metal foams. Progress in Materials Science, 46(6), 559-632. doi:10.1016/S0079-6425(00)00002-5
[3] Evans, A. G., Hutchinson, J. W., & Ashby, M. F. (1998). Cellular metals. Current Opinion in Solid State and Materials Science, 3(3), 288-303. doi: 10.1016/S1359-0286(98)80105-8
[4] Goodall, R., Despois, J. F., Marmottant, A., Salvo, L., & Mortensen, A. (2006). The effect of preform processing on replicated aluminium foam structure and mechanical properties. Scripta Materialia, 54(12), 2069-2073. doi: 10.1016/j.scriptamat.2006.03.003
[5] Greiner, C., Oppenheimer, S. M., & Dunand, D. C. (2005). High strength, low stiffness, porous NiTi with superelastic properties. Acta Biomaterialia, 1(6), 705-16. doi: 10.1016/j.actbio.2005.07.005
[6] Evans, A. G., Hutchinson, J. W., & Ashby, M. F. (1998). Cellular metals. Current Opinion in Solid State and Materials Science, 3(3), 288-303. doi: 10.1016/S1359-0286(98)80105-8
[7] Wilkes, T. E., Young, M. L., Sepulveda, R. E., Dunand, D. C., & Faber, K. T. (2006). Composites by aluminum infiltration of porous silicon carbide derived from wood precursors. Scripta Materialia, 55(12), 1083-1086. doi:10.1016/j.scriptamat.2006.08.040
[8] Furman, E. L.; Finkelstein, A. B.; Cherny, M. L. Permeability of Aluminium Foams Produced by Replication Casting. Metals 2013, 3, 49-57.
[9] Goodall, R., Despois, J. F., Marmottant, A., Salvo, L., Mortensen, A., The effect of preform processing on replicated aluminium foam structure and mechanical properties, Scripta Mater., 54 (2006) 2069-2073.
[10] Andreas Mortensen. “Porous metal article and method of producing a porous metallic article.” Publication U.S. Pat. No. 8,151,860 B2. Apr. 10, 2012.
[11] Trinidad, J., Marco, I., Arruebarrena, G., Wendt, J., Letzig, D., Sáenz de Argandoña, E. and Goodall, R. (2014), Processing of Magnesium Porous Structures by Infiltration Casting for Biomedical Applications. Adv. Eng. Mater., 16: 241-247. doi: 10.1002/adem.201300236
[12] P. S. Liu and G. F. Chen, Chapter Two—Making Porous Metals, In Porous Materials, edited by P. S. Liu G. F. Chen, Butterworth-Heinemann, Boston, 2014, Pages 21-112, ISBN 9780124077881, http://dx.doi.org/10.1016/B978-0-12-407788-1.00002-2. (http://www.sciencedirect.com/science/article/pii/B9780124077881000022)
[13] Conde, Y., Despois, J.-F., Goodall, R., Marmottant, A., Salvo, L., San Marchi, C. and Mortensen, A. (2006), Replication Processing of Highly Porous Materials. Adv. Eng. Mater., 8: 795-803. doi: 10.1002/adem.200600077
[14] Allaire, C. (2006) Interfacial Phenomena, in Fundamentals of Refractory Technology (eds J. P. Bennett and J. D. Smith), The American Ceramic Society, 735 Ceramic Place, Westerville, Ohio 43081. doi:-10.1002/9781118370940.ch16
[15] Kennedy, A. (2001). Porous Metals and Metal Foams Made from Powders.
[16] Ward, F. (1957). Standard Test Methods. Journal of the Textile Institute Proceedings, 1-9. doi:10.1520/E0009-09.2

What is claimed is:

1. A method of producing a porous metal comprising:
forming a salt preform structure comprising one or more openings in a vessel in a 3D polymer;
adding one or more metals to the salt preform structure;
melting the one or more metals into the salt preform structure in the vessel; and
dissolving the salt preform to produce the porous metal or alloy.
The method of claim 1, wherein the one or more metals are a metal alloy.

2. The method of claim 1, wherein the one or more metals are a metal alloy.

3. The method of claim 1, wherein the salt is NaCl, NaF, KCl, KF, LiCl, LiF, CaCl₂, CaF₂, BaCl₂, BaF₂, SrCl₂, SrF₂, MgCl₂, MgF₂, MgO, CaO, BaO, SrO, Na₂O and related oxides thereof.

4. The method of claim 1, wherein the salt is a Group I element containing salt, is a nitrate, a sulfate, a sulfide, a hydroxide, a carbonate, a phosphate, a fluoride, an oxide, a silver, a lead, a mercury, an antimony, or a bismuth salt.

5. The method of claim 1, wherein the vessel is a crucible.

6. The method of claim 1, further comprising the step of making the salt preform by obtaining a 3D printed mesh, forming or packing salt crystals in the 3D printed mesh, and removing the 3D mesh by burning or melting the 3D printed mesh to leave a salt preform structure.

7. The method of claim 1, further comprising the step of making the salt preform by obtaining a 3D printed mesh, forming or packing salt crystals in the 3D printed mesh, and removing the 3D mesh by burning or melting the 3D printed mesh and sintering the salt preform structure.

8. The method of claim 1, wherein the step of adding the one or more metals to the salt preform structure is defined further as comprising melting the one or more metals and casting the metal into the salt preform structure.

9. The method of claim 1, wherein a vent is positioned in fluid communication with the salt preform structure to permit gases or liquids to escape the salt preform structure during the addition or melting of the one or more metals into the salt preform structure.

10. The method of claim 1, wherein the step of dissolving the salt preform includes the addition of a solvent that dissolves the salt.

11. The method of claim 1, wherein the salt is dissolved with a solvent selected from at least of partially water soluble, water soluble, soluble in acids or alcohol, wherein the solvent does not react with the metal.

12. The method of claim 1, wherein the solvent is selected from HCl, HF, methanol, ethanol, propanol, butanol, ammonia, acetone, acetic acid, nitric acid, and combinations thereof.

13. The method of claim 1, wherein the one or more metals are selected from at least one or more metals selected from aluminum, antimony, bismuth, chromium, cobalt, copper, gallium, germanium, gold, hafnium, indium, iron, lead, magnesium, mercury, nickel, potassium, rhodium, tin, titanium, tantalum, uranium, plutonium, scandium, vanadium, zirconium, alloys, or oxides thereof.

14. The method of claim 1, wherein the salt preform structure is defined further as comprising one or more opening in one or more shapes selected from at least one of wires, blocks, cubes, spheres, cones, pyramids, vias, cylinders, pads, mesh, 3D periodic arrays.

15. The method of claim 1, wherein the salt preform structure is removed by dissolving the salt.

16. A method of producing a porous metal casting comprising:
forming a salt preform structure in a 3D printed polymeric matrix comprising one or more openings in a heat resistant vessel;
removing the 3D printed polymeric matrix by dissolving, melting, or sintering;
adding, melting or casting one or more metals into the salt preform structure; and
dissolving the salt preform structure to produce the porous metal casting.

17. The method of claim 16, wherein the one or more metals are a metal alloy.

18. The method of claim 16, wherein the one or more metals are a metal alloy.

19. The method of claim 16, wherein the salt is NaCl, NaF, KCl, KF, LiCl, LiF, CaCl₂, CaF₂, BaCl₂, BaF₂, SrCl₂, SrF₂, MgCl₂, MgF₂, MgO, CaO, BaO, SrO, Na₂O and related oxides thereof.

20. The method of claim 16, wherein the salt is a Group I element containing salt, is a a sulfate, a sulfide, a hydroxide, a carbonate, a phosphate, a fluoride, an oxide, a silver, a lead, a mercury, an antimony, or a bismuth salt.

21. The method of claim 16, wherein the vessel is a crucible.

22. The method of claim 16, wherein the step of adding the one or more metals to the preform structure is defined further as comprising melting the one or more metals and casting the metal into the salt preform structure.

23. The method of claim 16, wherein a vent is positioned in fluid communication with the salt preform structure to permit gases or liquids to escape the salt preform cast during the addition or melting of the one or more metals into the salt preform structure.

24. The method of claim 16, wherein the step of dissolving the salt preform structure includes the addition of a solvent that dissolves the salt.

25. The method of claim 16, wherein the salt is dissolved with a solvent selected from at least of partially water soluble, water soluble, soluble in acids or alcohol, wherein the solvent does not react with the metal.

26. The method of claim 16, wherein the one or more metals are selected from at least one or more metals selected from aluminum, antimony, bismuth, chromium, cobalt, copper, gallium, germanium, gold, indium, iron, lead, magnesium, mercury, nickel, potassium, rhodium, tin, titanium, uranium, plutonium, scandium, zirconium, alloys, or oxides thereof.

27. The method of claim 16, wherein the salt preform structure is defined further as comprising one or more opening in one or more shapes selected from at least one of wires, blocks, cubes, spheres, cones, pyramids, vias, cylinders, pads, mesh, 3D periodic arrays.
